(19) United States
(12) Patent Application Publication
(10) Pub. No.: US 2016/0368597 A1
(43) Pub. Date: Dec. 22, 2016

(54) Torque balanced, lift rotor module providing increased lift with few or no moving parts

(71) Applicant: Charles Howard Medlock, Hot Springs Village, AR (US)

(72) Inventor: Charles Howard Medlock, Hot Springs Village, AR (US)

(21) Appl. No.: 14/545,774

(22) Filed: Jun. 17, 2015

(51) Int. Cl. B64C 27/20

(52) U.S. Cl. CPC B64C 27/20; B64C 2201/027; B64C 2201/108

(57) ABSTRACT

A device and method are disclosed for continuous torque/anti-torque force balance, except for trim adjustments. The torque requirements of a single lift rotor are balanced while lifting varying load weights and with varying power settings. A single lift rotor plane of rotation is parallel to and just below the flared air entry end of a relatively short, cylindrical, vertical duct. The lift rotor is closely contained by the duct's inside diameter, and just above a fixed-pitch, essentially vertical, array of air foil shaped vanes. In this configuration, lateral lift in an anti-torque rotational direction is generated, in direct proportion to the lift rotor torque requirements by the forced interaction of the vanes with the swirl air flow component of the lift rotor's rotor wash.

### RELATED APPLICATIONS

The present application is a continuation in part application of U.S. application Ser. No. 13/232789, filed Sep. 14, 2011, which is a continuation application of U.S. provisional patent application, Ser. No. 61/405531, filed Oct. 21, 2010, for TORQUE BALANCED, LIFT ROTOR MODULE PROVIDING INCREASED LIFT WITH FEW OR NO MOVING PARTS, by Charles H Medlock, included by reference herein and for which benefit of the priority date is hereby claimed.

### FIELD OF THE INVENTION

The present invention relates to an aircraft or aerial crane which achieves torque/anti-torque balance, and to methods of torque balance and control of a single lift rotor and, more particularly, to torque balance and control of a single lift rotor using its rotor wash and swirl component to generate anti-torque, lateral lift within a duct, using a fixed-pitch, essentially vertical, array of air foil shaped vanes.

### BACKGROUND OF THE INVENTION

Single rotor aerial cranes, unmanned aerial vehicles, and all other single rotor, rotor craft have to be designed to counter or eliminate and control the torque resulting from a rotating power source rotating a single lift rotor in order to generate lift and stabilize the load being lifted isolating the load from the torque and torque reaction. Without torque control the load or craft being lifted will spin in the opposite direction of the lift rotor since every action causes and equal but opposite reaction, torque force causes a reaction of torque force in the opposite rotational direction. This torque reaction must be constantly balanced with anti-torque force in order to isolate the load from its effects and control lift and horizontal movement or flight.

Torque is present at the center of lift when a single lift rotor lifting a load is rotated by a rotary torque power source in order to generate the lift required to lift a load, as in, for instance the main lift rotor drive shaft connecting a rotary torque power source to the main lift rotor of a helicopter. The heavier the load, the more lift required; the more lift required, the more torque necessary to turn the rotor and the more anti-torque force required to balance torque. The dynamic of varying load weight and torque power settings when using a lift rotor to lift a load determine the constantly changing amount of torque and requires a constant balance of anti-torque force in order to keep the load under control rotationally. The anti-torque force must constantly be equal to the torque force in order to maintain a horizontal heading and keep the front of the craft or load facing a desired direction. Rotational stability is a necessary ingredient for controlled flight or aerial lifting and placement or delivery of a load using a single lift rotor. Balancing torque requirements with anti-torque has been a challenge from the beginning of single lift rotor vertical lifting and flight.

Various methods have been developed to accomplish torque control and torque balance including but not limited to contra rotating rotors, tandem or multiple counter-rotating rotors, tail rotors, tip jets etc. All these approaches result in a design which is complex, require technical training to use and are expensive to purchase and maintain. Tip jets have proven all but impractical because of problems getting fuel to the tips of a spinning rotor, where the jets or propellers, are located and dealing with the centrifugal forces moving towards the tips. The three most common methods of controlling the torque of a single lift rotor while it is lifting a load are contra rotating rotors, counter rotating rotors and the tail boom, operating outside the diameter of the main lift rotor.

Contra rotating rotors use a shaft within a shaft in order to spin two lift rotors in opposite directions, thereby canceling one lift rotor's torque with the torque of the other. Contra rotating rotors require technical training, a complicated set of controls and an expensive drive train and transmission. Synchronizing the pitch of the props to transfer air smoothly between the lift rotors and downward in forward movement under varying load and wind conditions requires a lot of skill and or programming and precision controls. Contra rotating propellers have problems at higher speeds, like all lift rotors, because as one lift rotor blade is advancing the other is retreating. This causes unbalanced lift, more lift from the advancing blade and less lift from the retreating blade. Contra rotating lift rotors are actually a safer, better system than the one used more commonly.

The most common method of balancing the torque of a single lift rotor is used on most helicopters called the tail boom, most with an open propeller or other means of directing force at a right angle to the shaft turning the main rotor, and operating outside the main lift rotor's rotor wash. The tail boom operates outside of the main rotor's rotor wash and has been used in various configurations, including shrouded rotors, air straightening vanes, variable pitch propellers, directionally ducted exhaust, and in combination with a thruster propeller to help with horizontal thrust. All of these tail boom methods to control torque using a tail boom have drawbacks and are innately inefficient because they all push the load sideway using energy taken away from, and necessarily countered by lift generation. Tail boom torque control uses up to 30% of the total horse power of the craft using it. The third type of torque control is used mainly by the military and isn't actually single rotor torque control. It is counter rotating rotors on different rotating shafts, usually at opposite ends of the craft. This counters the torque but presents new challenges of control as loads vary and wind, mission requirements and terrain conditions are in constant flux.

Helicopters using a tail boom expend up to 30% of the total power of the craft to balance torque and they are very expensive for most individuals to own and maintain and require a lot of training and practice to fly. Tandem, counter rotating rotors located at opposite ends of a craft are very expensive for most individuals to own and maintain and require a lot of training and experience to fly. Contra rotating torque control methods are very expensive for most individuals to own and maintain and are very complicated and require training and experience to gain proficiency.

The most common method of torque control, using a tail boom outside of the main rotor's rotor wash not only uses up to 30% of the total horse power of the helicopter, the tail rotors have caused death and destruction of property by striking the ground, objects or people. Tail boom methods are ineffective to the extent they, by design, push the craft or load sideways as they balance or control the torque of the main rotor because the force they generate originates 12 to 40 feet from the center of the torque they are countering, balancing and controlling. Controlling a helicopter is a complicated process, of balancing lift by constantly changing the pitch of the lift rotor's blades, controlling torque, by changing the speed/pitch of the tail rotor, directing horizontal movement, by changing the center of gravity with the tilt of the main lift rotor. This is especially complicated during hover, landing, and takeoff. Hovering a helicopter in ground effect, above the ground within the diameter of the rotor, especially over slanted geography, as in a search and rescue can and has caused unbalanced circulation of the rotor wash and unbalanced lift causing the helicopters to roll and crash.

### SUMMARY OF THE INVENTION

In accordance with the present invention, there is provided a method and device for continuously countering the torque requirements of a single lift rotor lifting a load under varying load weights and power settings with anti-torque, lateral lift, force, except for trim adjustments. The counter-torque, torque balance is achieved through the use of a lift rotor with a rotor wash with a swirl air flow component and with a plane of rotation parallel to, and just above a fixed-pitch, essentially vertical, array of air foil shaped vanes, a control mount, and a relatively short, cylindrical, vertical duct, flared at the top, air entry end, below which is the lift rotor plane of rotation. In this configuration, these elements can provide continuous, automatic, absolutely dependable torque/anti-torque force balance of a single lift rotor lifting a load under varying load weights and power settings except for trim adjustments.

The configuration requires the relatively short, cylindrical, vertical duct to be of an inside diameter to closely surround the lift rotor diameter of rotation for increased lift and attached to the fixed-pitch, essentially vertical, array of airfoil shaped vanes and long enough for a relatively small vertical space between the lift rotor plane of rotation and the fixed-pitch, essentially vertical, array of air foil shaped vanes located parallel to and below the lift rotor plane of rotation, near the relatively short, cylindrical, vertical duct air exit end. An optional method of trim may be required.

Trim could even be accomplished with completely fixed vanes in the downdraft by setting them at an optimal angle of attack at a certain blade rpm. Less rpm would provide slightly less anti-torque force, allowing rotation in the rotor blades direction of rotation and more rpm would provide slight more anti-torque force and cause the craft or drone to turn with the blades direction of rotation. This would require testing for balanced torque at a given load and eliminate the benefit of constant torque (balance) control at varying loads.

It is therefore an object of the invention to provide a method and device for maintaining constant balance of the torque requirements of a single lift rotor lifting a load under varying load weights and power settings with anti-torque force.

It is another object of the invention to provide a failsafe method and device for balancing the torque required to turn a lift rotor while lifting a load under varying load weights and power settings with anti-torque force.

It is another object of the invention to provide a system of balancing the torque required by a single lift rotor while lifting a load and providing increased lift or thrust under varying load weights and power settings.

It is another object of the invention to provide a simple means of balancing the torque requirements of a single lift rotor lifting a load under varying load weights and power settings with anti-torque force.

It is another object of the invention to provide an inexpensive method and device for balancing the torque requirements of a single lift rotor lifting a load under varying load weights and power settings with anti-torque force.

It is another object of the invention to provide a relatively light weight method and device for balancing the torque requirements of a single lift rotor lifting a load under varying load weights and power settings with anti-torque force.

It is another object of the invention to provide a method and device for balancing the torque requirements of a single lift rotor with no moving parts while lifting a load under varying load weights and power settings with anti-torque force.

It is another object of the invention to provide a method and device for balancing the torque requirements of a single lift rotor while providing 20 to 50% more lift while lifting a load under varying load weights and power settings with anti-torque force.

It is another object of the invention to provide a method and device for balancing the torque requirements of a single lift rotor that is automatic and failsafe while lifting varying load weights and power settings with anti-torque force.

It is another object of the invention to provide a method and device for balancing the torque requirements of a single lift rotor with lateral lift anti-torque force while lifting varying load weights and power settings.

It is another object of the invention to provide a method and device for balancing the torque requirements of a single lift rotor lifting varying load weights and under varying power settings that is modular.

It is an object of this invention to provide a device for continuous torque/anti-torque force balance of an aerial vehicle or lifting device. The device has a relatively short, cylindrical, vertical duct having a flared at the top air entry end and a bottom air exit end; a fixed-pitch, essentially vertical array of air foil shaped vanes, each vane having an outside end, an inside end, a leading edge and a trailing edge, the outside end is attached to the relatively short, cylindrical, vertical duct's inside diameter with the trailing edge ending at or near the bottom air exit end of the duct; and The inside end attached to a Control mount; wherein the leading edge of the air foil shaped vanes points upward toward the duct's flared at the top air entry end.

It is an object of this invention to provide a device for continuous torque/anti-torque force balance of an aerial vehicle or lifting device. The device has a relatively short, cylindrical, vertical duct having a flared at the top air entry end and a bottom air exit end; a fixed-pitch, essentially vertical array of air foil shaped vanes, each vane having an outside end, an inside end, a leading edge and a trailing edge, the outside end is attached to the relatively short, cylindrical, vertical duct's inside diameter with the trailing edge ending at or near the bottom air exit end of the duct; and The inside end attached to a Control mount; wherein the leading edge of the air foil shaped vanes points upward toward the duct's flared at the top air entry end. The device also has a Lift rotor drive mechanism passing through the control mount.

It is an object of this invention to provide a device for continuous torque/anti-torque force balance of an aerial vehicle or lifting device. The device has a relatively short, cylindrical, vertical duct having a flared at the top air entry end and a bottom air exit end; a fixed-pitch, essentially vertical array of air foil shaped vanes, each vane having an outside end, an inside end, a leading edge and a trailing edge, the outside end is attached to the relatively short, cylindrical, vertical duct's inside diameter with the trailing edge ending at or near the bottom air exit end of the duct; and The inside end attached to a Control mount; wherein the leading edge of the air foil shaped vanes points upward toward the duct's flared at the top air entry end. The device also has a Lift rotor drive mechanism passing through the control mount and lift rotor blades attached to the lift rotor drive mechanism.

It is an object of this invention to provide a device for continuous torque/anti-torque force balance of an aerial vehicle or lifting device. The device has a relatively short, cylindrical, vertical duct having a flared at the top air entry end and a bottom air exit end; a fixed-pitch, essentially vertical array of air foil shaped vanes, each vane having an outside end, an inside end, a leading edge and a trailing edge, the outside end is attached to the relatively short, cylindrical, vertical duct's inside diameter with the trailing edge ending at or near the bottom air exit end of the duct; and The inside end attached to a Control mount; wherein the leading edge of the air foil shaped vanes points upward toward the duct's flared at the top air entry end. The device also has a

Lift rotor drive mechanism passing through the control mount a single lift rotor is aligned perpendicular to the drive mechanism.

It is an object of this invention to provide a device for continuous torque/anti-torque force balance of an aerial vehicle or lifting device. The device has a relatively short, cylindrical, vertical duct having a flared at the top air entry end and a bottom air exit end; a fixed-pitch, essentially vertical array of air foil shaped vanes, each vane having an outside end, an inside end, a leading edge and a trailing edge, the outside end is attached to the relatively short, cylindrical, vertical duct's inside diameter with the trailing edge ending at or near the bottom air exit end of the duct; and The inside end attached to a Control mount; wherein the leading edge of the air foil shaped vanes points upward toward the duct's flared at the top air entry end. The device also has a Lift rotor drive mechanism passing through the control mount The device of claim 1 wherein the fixed-pitch, essentially vertical air foil shaped vanes are distributed evenly around the inside diameter of the duct. The vanes may be symmetrical or asymmetrical. The vanes may be pitched from 0 to 20 degrees from vertical. The array of vanes are attached to the duct at or near the air exit end of the duct.

It is an object of this invention to provide a vertical takeoff and landing vehicle or

VTOL lifting device capable of continuous torque/anti-torque force balance having a relatively short, cylindrical, vertical duct having a flared at the top air entry end and a bottom air exit end; a fixed-pitch, essentially vertical array of air foil shaped vanes, each vane having an outside end, an inside end, a leading edge and a trailing edge, the outside ends attached to and distributed around the relatively short, cylindrical, vertical duct's inside diameter with trailing edges ending at or near the bottom air exit end of the duct; the inside end attached to a Control mount; wherein the leading edge of the air foil shaped vanes points upward toward the duct's flared at the top air entry end; a Lift rotor drive mechanism passing through the Control mount; and lift rotor blades attached to the lift rotor drive mechanism, wherein the vehicle is capable of continuous torque/anti-torque force balance.

It is an object of the invention to provide a method of countering the torque required by a single lift rotor, rotating within a vertical duct in a plane of rotation parallel to and just above a vertical or near vertical array of air foil shaped vanes; wherein lateral lift in an anti-torque direction results from rotor wash passing through the array of vanes.

It is an object of the invention to provide a method of countering the torque required by a single lift rotor, rotating within a vertical duct in a plane of rotation parallel to and just above a vertical or near vertical array of airfoil shaped vanes. Lateral lift in an anti-torque direction results from rotor wash passing through the array of vanes.

It is an object of the invention to provide a method of countering the torque required by a single lift rotor, rotating within a vertical duct in a plane of rotation parallel to and just above a vertical or near vertical array of air foil shaped vanes. Lateral lift in an anti-torque direction results from rotor wash passing through the array of vanes and the anti-torque balances the torque.

It is an object of the invention to provide a method of countering the torque required by a single lift rotor by rotating the lift rotor within a vertical duct in a plane of rotation parallel to and just above a vertical or near vertical array of air foil shaped vanes. Lateral lift in an anti-torque direction results from rotor wash passing through the array of vanes.

It is an object of the invention that the ratio of torque to anti-torque is maintained under varying load weights.

It is an object of the invention that the ratio of torque to anti-torque is maintained under varying power settings.

It is an object of the invention to provide a method of increasing lift generation by having the inside diameter of a short cylindrical vertical duct and the diameter rotation of the lift rotor closely fitted to each other so that high pressure air is forced downward through the duct.

It is an object of the invention to provide a method increasing lift generation by having the inside diameter of a short cylindrical vertical duct that is flared at the top, air entry end and the diameter rotation of the lift rotor closely fitted to each other so that high pressure air is forced downward through the duct. Flaring the duct outward, on the intake end, increases the air flow, because the lift rotor pressurizes the air below it as it is drawn into the duct and that increases lift.

It is an object of the invention to provide a device for continuous torque/anti-torque force balance of an aerial vehicle or lifting device comprising, a relatively short, cylindrical, vertical duct having a flared at the top air entry end and a bottom air exit end, a fixed-pitch, essentially vertical array of air foil shaped vanes, each vane having an outside end, an inside end, a leading edge and a trailing edge, the outside end is attached to the relatively short, cylindrical, vertical duct's inside diameter trailing edge ending at or near the bottom air exit end of the duct, and the inside end attached to a Control mount, wherein the leading edge of the air foil shaped vanes points upward toward the duct's flared at the top air entry end.

The device might also have a lift rotor drive mechanism passing through the control mount.

The device might also have a lift rotor blades attached to the lift rotor drive mechanism.

The device might also have lift rotor blades rigidly attached to the lift rotor drive mechanism. A single lift rotor is aligned perpendicular to the drive mechanism.

The fixed-pitch, essentially vertical air foil shaped vanes are distributed evenly around the inside diameter of the duct.

The fixed-pitch array of air foil shaped vanes can be symmetrical or asymmetrical.

The vanes of the device can be set at an angle between zero and 10 degrees from vertical.

The vanes of the device can be set at an angle between zero and 20 degrees from vertical.

The trailing edges of vanes could be attached to the duct at or near the air exit end of the duct.

It is an object of the invention to provide a vertical takeoff and landing, aerial vehicle or lifting device capable of continuous torque/anti-torque force balance, comprising a relatively short, cylindrical, vertical duct having a flared at the top air entry end and a bottom air exit end, a fixed-pitch, essentially vertical array of air foil shaped vanes, each vane having an outside end, an inside end, a leading edge and a trailing edge, the outside ends attached to and distributed around the relatively short, cylindrical, vertical duct's inside diameter with trailing edges ending at or near the bottom air exit end of the duct, the inside end attached to a control mount; wherein the leading edge of the air foil shaped vanes points upward toward the duct's flared at the top air entry end, a Lift rotor drive mechanism passing through the control mount or being a rim drive added to the lift rotor diameter, by friction, chain, belt or magnetic, and lift rotor blades attached to the lift rotor drive mechanism, wherein the vehicle is capable of continuous torque/anti-torque force balance.

It is an object of the invention to provide a method of countering the torque generated by a single lift rotor, comprising: rotating the lift rotor within a vertical duct in a plane of rotation parallel to and just above a vertical or near vertical array of air foil shaped vanes; wherein lateral lift in an anti-torque direction results from rotor wash passing through the array of vanes.

It is an object of the invention to provide a method wherein the anti-torque force countering the torque is sufficient to balance the torque.

It is an object of the invention to provide a method wherein the inside diameter of the duct is closely fitted to the diameter of the lift rotor.

It is an object of the invention to provide a method wherein the vertical duct is cylindrical.

It is an object of the invention to provide a method wherein the vertical duct is flared at the top air entry end.

It is an object of the invention to provide a method wherein the ratio of torque to anti-torque is maintained under varying load weights.

It is an object of the invention to provide a method wherein the ratio of torque to anti-torque is maintained under varying power settings.

The problem to be solved was to build a self-stabilized VTOL aerial vehicle or lifting device capable of balancing the torque and anti-torque forces generated by a single lift rotor, using only the downdraft, within the same diameter as the lift rotor.

### The Solution

The present invention is a torque/anti-torque control system that solves the problem of self-stabilization by locating a lift rotor over vertical airfoils arrayed within a flared duct to create “lateral lift” in an anti-torque direction. Our testing shows 100% of the torque can be balanced with anti-torque, even while the vanes are at a low angle of attack and the torque remains in balance, except for minor trim adjustments, even when power and load are increased or decreased. As power is increased, the downdraft is increased and the anti-torque forces are increased. Control of torque is built into the structure of the module. The result is a self-stabilized device with continuous torque control of a single lift rotor lifting a load while increasing lift.

### Advantages

The present invention provides the ability to lift from any stable platform. The present invention does not require transmissions, bearings, a cyclic or collective. The present invention provides the advantage of having few or no moving parts. The present invention can be made in almost infinite sizes. The present invention provides the advantage of turning wasted energy into productive energy. The present invention can work equally well above or below a load being lifted. The present invention provides the safety advantage of having no exposed rotor blades. The present invention can be made by injection molding or by 3D printing.

### Utility Statement

The present invention has many uses. Some non-limiting examples are: as a toy radio controlled craft, a radio controlled aerial crane, an unmanned aerial vehicle, a personal aerial vehicle. The present invention can be used in Forest and Crop Inspection, Search and Rescue, Border Patrol, Sport, Personal and group Transportation, delivering supplies to Remote Locations, Mobility for the Handicapped, Disaster Evacuation, Exploration, Sight Seeing, Military Defense, and aerial reconnaissance. The present invention can be used for family sport, local, and regional travel, commercial and industrial lifting and transport.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a top perspective view of a torque balanced, lift rotor module, providing increased lift, with few or no moving parts assembly consisting of a swirl air flow a duct surrounding an array of air foil shaped vanes beneath a lift rotor driven by a lift rotor, drive mechanism and attached to the inside diameter of the duct, below the lift rotor and to a central control mount at the other lengthwise end of each air foil;

FIG. 2 is a bottom perspective view of a torque balanced, lift rotor module, providing increased lift, with few or no moving parts assembly consisting of a swirl air flow a duct surrounding an array of air foil shaped vanes beneath a lift rotor driven by a lift rotor, drive mechanism and attached to the inside diameter of the duct, below the lift rotor and to a central control mount at the other lengthwise end of each air foil; and

FIG. 3 is a top view of a torque balanced, lift rotor module, providing increased lift, with few or no moving parts assembly consisting of a swirl air flow a duct surrounding an array of air foil shaped vanes beneath a lift rotor driven by a lift rotor, drive mechanism and attached to the inside diameter of the duct, below the lift rotor and to a central control mount at the other lengthwise end of each air foil.

For purposes of clarity and brevity, like elements and components will bear the same designations and numbering throughout the Figures.

### DESCRIPTION OF THE INVENTION

Terms and Definitions

“Vanes” as used herein, also referred to as an “array of vanes” means an array of fixed-pitch, essentially vertical air foil shaped vanes located closely below the rotor blades. The vanes interact with rotor wash to generate anti-torque lateral lift. The vanes connect at one end to the center control mount and at the other end to the duct.

“Essentially Vertical” as used herein means that the pitch of a vane is either vertical or nearly vertical. The pitch of a vane or array of vanes might be set at between zero and twenty degrees from vertical.

“Asymmetrical Vanes” as used herein is more flat on one side and more air foil shaped on the other side.

“Symmetrical Vanes” as used herein has the same camber, caster and airfoil shape on both sides. The cord is in the center of the vane and both sides are identical. In a preferred embodiment, the asymmetrical fixed-pitch, essentially vertical Array of air foil shaped vanes 1 have a cord of 6″, a camber of three fourth of an inch and have an asymmetrical air foil cross section 24″ long. The asymmetrical vanes 1 are positioned so their trailing edges are on or about the same horizontal plane as the vertical Duct 10 air exit end, and their leading edge extends upward to about one and one half inches below the parallel plane of the Lift rotor 12 rotation and parallel to it. The vanes 1 have a 7 degree pitch angle from vertical, the leading edge being tilted towards the direction of the Lift rotor 12 rotation.

“Duct” as used herein means a relatively short, cylindrical, vertical Duct flared at the top, air entry end. The flared end is located just above the horizontal plane of the lift rotor. The Duct is long enough that the plane of rotation of the lift rotor is below the flare and below the plane of rotation is a short vertical space. In a preferred embodiment that space is 1.5 inches. Below the space is an array of airfoil shaped vanes at or near the base of the Duct. The duct contains the rotor wash, forcing it to interact with vanes and the duct eliminates tip vortexes of the lift rotor. The duct is connected to and supported by the outer ends of the vanes, and it is close fitting to the diameter of the lift rotor.

“Lift rotor” as used herein means a propeller having at least two airfoils (propeller blades) at an angle of attack or pitch to do work and lift a load when sufficient torque is applied. The rotation coupled with the angle of attack creates the swirl airflow beneath it. The lift rotor attaches in the center to a rotational torque generator by a drive shaft or by a rim drive attached to the rotor blades.

“Single lift rotor” as used herein means that only a single lift rotor is used in the Assembly.

A “rotor blade” as used herein is a propeller blade, an airfoil as commonly understood. An airfoil is any surface producing more lift than drag when passing through the air at a suitable angle. Airfoils are most often associated with production of lift. Airfoils are also used for stability (fin), control (elevator), and thrust or propulsion (propeller or rotor). Certain airfoils, such as rotor blades, combine some of these functions. The main and tail rotor blades of a helicopter are airfoils, and air is forced to pass around the blades by mechanically powered rotation. Airfoils are carefully structured to accommodate a specific set of flight characteristics. Helicopters are able to fly due to aerodynamic forces produced when air passes around the airfoil.

“Rotor wash” as used herein means air turbulence caused by the lift rotor as commonly understood. Rotor wash as it leaves the bottom, high pressure, side of a lift rotor (at its angle of attack) created by friction between the lift rotor, rotation and the surrounding air, creating a vertical Swirl air flow 16 component of rotor wash. The horizontal movement element of the swirl airflow produces lateral lift from the low pressure side of the almost vertical airfoils and lateral thrust from the high pressure side of the almost vertical airfoils. Both the high pressure and low pressure created by the swirl airflow, passing by the airfoil, vane sides of the almost vertical vanes combine to balance torque with anti-torque rotational force. The swirl occurs between the lift rotor and the almost vertical vanes. The swirl is generated at the lift rotor and interacts with the almost vertical vanes.

“Control mount” as used herein means a structure that provides a rigid, bridge-like connection supporting the inner most end of the vanes to a load or craft. The control mount may be circular with a surface for attaching to a load or craft. The control mount allows a drive shaft or other torque transmitter to pass through it to provide rotating torque to the lift rotor. The control mount attaches to the inner end of the vanes, and supports vanes, and also attaches to a load or craft. The control mount is also referred to as “center control mount” or “central control mount”.

“Drive shaft” as used herein is a device for providing transmission of rotational torque from torque generator to the lift rotor. The drive shaft is round with a diameter large enough and long enough to connect lift rotor to torque generator. The drive shaft is connected to the lift rotor and a motor, engine, or other torque generator and passes through the control mount. The driveshaft may just provide stability for the lift rotor in the case of a rim drive whether belt, friction, chain, or magnetic.

“Load” as used herein is the combined load of a craft itself and any weight it might be carrying or lifting. Load pulls a craft downward because of the force of gravity. Load opposes lift and acts vertically downward through the craft's center of gravity. To lift craft or load off the ground vertically, the rotor system must generate enough lift to overcome or offset the total load of the craft and any weight it is carrying or lifting. Load is synonymous with “weight”.

“Lift” as used herein means the force that opposes the downward force of load.

Lift is produced by the dynamic effect of the air acting on the lift rotor, and acts perpendicular to the flight path through the center of lift.

“Trim” is the fine adjustment to torque control. It is the essential option to make the module completely controllable. Trim can be accomplished in many ways. For example, adjustable flaps that would extend from the essentially vertical vanes or stubby, adjustable, variable pitch airfoils mounted around the inside diameter of the duct, between the fixed airfoil shaped vanes. Air diverted from the lift rotor's rotor wash jetting out of the sides of the duct in an anti-torque direction, or making some or all of the vanes variable pitch.

“Torque-Balanced Lift Rotor Module having no moving parts” as used herein is an assembly comprised of a duct, an array of vanes, and a control mount. The Module provides increased Lift and provides control of the torque requirements of a lift rotor while it is lifting a load. Also referred to herein as the “Assembly” or the “Module”.

“Torque-Balanced Lift Rotor Module having few moving parts” as used herein is an assembly comprised of a duct, an array of vanes, shaft, a control mount, and a lift rotor. The Module provides increased Lift compared to a rotor spinning in free air, and provides control of the torque requirements of a single lift rotor while it is lifting a load. Also referred to herein as the “Assembly” or the “Module”.

“Yaw” as used herein has the meaning generally understood. Yaw is the movement of a craft about its vertical axis.

“Torque” as used herein has the generally understood meaning. Torque is the tendency of a craft to turn in the opposite direction of the rotor's rotation. According to Newton's law, “for every action there is an equal and opposite reaction,” such that the rotor, if turning clockwise, imparts a tendency for the aircraft to rotate counterclockwise. A single engine aircraft having a propeller rotating clockwise, will tend to rotate counter clockwise.

A quick review of aeronautical terms, their meanings and their application to helicopter flight principals can be found in the HELICOPTER FLYING HANDBOOK FAA-H-8083-21A (2012) United States Department of Transportation, Federal Aviation Administration Flight Standards Service Airman Testing Standards Branch, AFS-630, P.O. Box 25082, Oklahoma City, Okla. 73125.

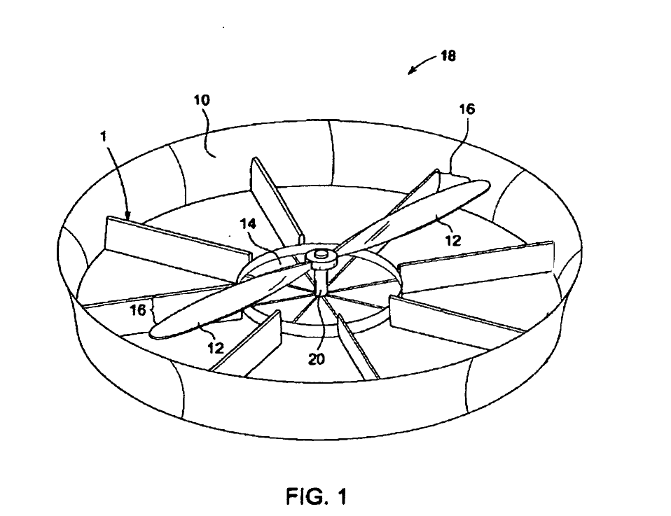

FIG. 1 is a top perspective view of a Torque-Balanced Lift rotor Module Assembly 18. A single Lift rotor 12 is rigidly attached to a Lift rotor drive mechanism 20. The Lift rotor drive mechanism 20 passes through a Control mount 14, shown here in the embodiment, as a drive shaft. The Lift rotor drive mechanism 20 passes through a Control mount 14 making a connection between the lift rotor 12 and the torque generator. The control mount 14 is centered in a relatively short, cylindrical, vertical Duct 10 that is flared at the air entry end. The duct is closely fitted to the Lift rotor 12 diameter of rotation for the attenuation of tip vortexes to increase lift. A fixed-pitch, essentially vertical Array of air foil shaped vanes 1 is located below, and parallel to the Lift rotor 12 in the Lift rotor's 12 rotors wash and Swirl air flow 16. The array of vanes 1 is attached to a Control mount 14 at the lengthwise end closest to a center point of the inside diameter of the Duct 10. The array of vanes 1 is attached at the other lengthwise end to the inside diameter of the Duct 10 extending downward and ending at, near, or beyond the bottom or air exit end of the Duct 10.

A short vertical space is located below the Lift rotor 12 and a Control mount 14 for attaching the Assembly 18 to a load, and the Lift rotor 12 to a rotary torque generator through a Lift rotor drive mechanism 20, and for allowing for control of tilt of the Torque-Balanced Lift rotor Module Assembly 18 independent of the load to be lifted by it. In the preferred embodiment the Control mount 14 is located in the center of the Duct 10, but could be built into the Assembly 18 in other ways, such as having control surfaces as part of the Duct 10, or the Array of vanes 1.

In the preferred embodiment, the Control mount 14 in the center of the Duct 10 could be raised or lowered for strength reasons or to provide proper positioning of the Lift rotor 12 or the Torque-Balanced Lift rotor Module Assembly 18.

In the preferred embodiment, the Lift rotor 12 has two Lift rotor blades, with air foil cross sections, but may have more than two blades. In the preferred embodiment, the Lift rotor blades are electronic in flight adjustable pitch, like the IVOPROP™ Electric In-Flight Adjustable Ultralight Model, or the IVOPROP™ Magnum Model Electric In-Flight Adjustable Propeller, by the by Ivoprop Corporation in Long Beach, Calif. In other embodiments a ground pitch adjustable lift rotor can be used, such as the IVOPROP™ Quick Ground Adjustable Medium Propeller, or the IVOPROP™ Quick Ground Adjustable Magnum Propeller.

The lift rotor blades are set at a pitch to provide necessary lift being connected by its Lift rotor drive mechanism 20 and turned by any rotary torque generator of the right capacity, such as a gasoline, internal combustion engine or an electric motor, for enough rotary torque generation and rounds per minute to accomplish its purpose. In the preferred embodiment the Array of vanes 1 are asymmetrical, but could be symmetrical air foil shapes. The Duct 10 inside diameter and the Lift rotor 12 diameter of rotation within the Duct 10 should be closely fitted thereby attenuating the lift rotor's tip vortexes, increasing lift and creating greater lift capacity.

Attenuating the lift rotor's tip vortexes and increasing lift requires the lift rotor's plane of rotation to be positioned parallel to and below the relatively short, vertical, cylindrical Duct 10 flared opening at the top, air entry end and its diameter when rotating to be close to the inside diameter of the Duct 10 inside diameter through 360 degrees of rotation. The Duct 10 should be strong and rigid enough to dampen vibration and light weight for added net lift capacity, and rigid enough to maintain its cylindrical shape and positioning under the stresses of various air pressures and air flow from different directions to accomplish the purpose for which its shape and position is intended. These air pressures and air flows are a result of air being pulled into the flared air entry end of the relatively short, cylindrical, vertical Duct 10 by the Lift rotor 12 blades low pressure top surface and by the Lift rotor 12 blade high pressure bottom surface to generate lift at high revolutions per minute, up to 2,500 revolutions per minute for a 72″ diameter Lift rotor 12, and from the air pressures and air flows interaction with the Duct 10 inside and outside diameter while lifting a load and in horizontal flight or movement. Carbon fiber composite, or some other strong, lightweight material would be suitable for fabricating the Duct 10 with a flared air entry at the top, an Array of vanes 1, and a center Control mount 14 all in one mold or formed together. The Array of vanes 1 should be attached or molded to the inside diameter of the Duct 10 at one lengthwise end and at the other lengthwise end to each other in the center or a center Control mount 14 as needed. In the preferred embodiment, the leading edges of vanes 1 extending upward towards the Lift rotor's 12 rotor wash and Swirl air flow 16 component. The trailing edges extend downward towards, at, or below the duct's air exit, but may be attached to themselves or some other fixture, as appropriate for the purpose, in the center of the Duct 10 diameter and just below the Lift rotor 12.

The Array of vanes 1 should have a degree of pitch in relation to the Lift rotor's 12 rotor wash and Swirl air flow 16 in order to create and balance anti-torque, lateral lift 360 degrees around the inside circumference of the Duct 10 while impeding air flow and lift as little as possible, and can be sized and positioned in various ways to achieve this purpose. There is a Swirl air flow 16 component of rotor wash created beneath every rotary lift-producing rotor blade caused by friction between the rotor blade and the air in which it is turning and more particularly by the pitch of the rotor blade pulling air downward with its top, low pressure side, and pushing air down with its bottom, high pressure side, which is necessary for lift generation. The greater the pitch of a rotor blade, the greater the rotor wash and Swirl air flow 16 component beneath the rotor blade while producing rotary lift.

The Swirl air flow 16 component of rotor blade rotor wash moves downward, away from the high pressure bottom side of the rotor blades and is drawn and pushed in the same rotational direction as the Lift rotor 12 rotation. This Swirl air flow 16 component of Lift rotor's 12 rotor wash is always present and is counterproductive for lift generation to the degree it is a sideways air flow instead of a vertical, lift air flow. The Swirl air flow 16 component of rotor wash takes energy to generate and wastes part of the energy by not being straight line vertical lift.

The present invention utilizes wasted swirl energy by using a ducted air flow to cause the Swirl air flow 16 component of rotor wash and the rotor wash itself to interact with an Array of vanes 1 to create anti-torque lateral lift. Overall efficiency of single rotor lifting methods is increased while continuously controlling and balancing 100% of the torque requirements of a single Lift rotor 12 with anti-torque lateral lift even while the torque requirements and loads are constantly varying.

In the Torque-Balanced Lift rotor Module Assembly 18 the Swirl air flow 16 component of rotor wash is forced by the Duct 10 to interact with the Array of vanes 1 located downstream in the Lift rotor's 12 rotor wash. Decreasing pressure on The Array of vanes 1 low pressure side, facing the direction of the Lift rotor 12 rotation, and increasing pressure on the Array of vanes 1 high pressure side, facing opposite the direction of the Lift rotor 12 rotation, adds greatly to anti-torque lateral lift creation. That makes it possible to balance and control the torque required by a single Lift rotor 12 to within its own diameter. In the preferred embodiment the rotor blade are pitched at 30″ of pitch and have a rotation diameter of 72″.

The Lift rotor 12 is centered vertically within the relatively short, cylindrical, vertical duct 10 inside diameter, with a plane of rotation parallel to and just below the flared top, air entry end of the relatively short, cylindrical, vertical duct 10 flared at the air entry end with an inside diameter of 73″ and a total height of about nine and one half inches.

In a preferred embodiment, the asymmetrical fixed-pitch, essentially vertical

Array of air foil shaped vanes 1 have a cord of 6″, a camber of three fourth of an inch, have an asymmetrical air foil cross section 24″ long. The asymmetrical vanes 1 are positioned so that their trailing edges are on or about the same horizontal plane as the vertical Duct 10 air exit end, and their leading edge extends upward to about one and one half inches below the parallel plane of the Lift rotor 12 rotation and parallel to it. The vanes 1 have a 7 degree pitch angle from vertical, the leading edge being tilted towards the direction of the Lift rotor 12 rotation.

The asymmetrical fixed-pitch, essentially vertical Array of air foil shaped vanes 1 are positioned within the Duct 10 so their flatter air foil surface with the sharper portion of the leading edge on it, their high pressure surface facing opposite the direction of the Lift rotor 12 rotation and their more rounded air foil surface, with the more rounded part of the leading edge is facing the same direction as the Lift rotor 12 rotation. The pitch of each vane 1 may be set at any degree from vertical that is suitable for producing anti-torque.

More pitch equals less lift. The pitch should be only enough to balance torque and anti-torque. More would be a waste of energy and both less pitch and too much pitch require more trim and are therefore wasteful and unnecessary. The duct will cause any degree of pitch to work to some degree, but the wrong pitch will decrease efficiency and lift. There is an exactly right amount of pitch for any combination of airfoil, size and design and diameter of lift rotor and duct. The best or right amount of pitch for a given load/power, size module and airfoil shape is by trial and error or by computer modeling.

In a preferred embodiment, the vanes 1 are made of carbon fiber and molded, for rigid attachment, to the center Control mount 14 and to the inside diameter of the Duct 10. This preferred embodiment will continuously balance the torque required by a single Lift rotor 12 with anti-torque lateral lift with the same vertical center as the center of torque requirement for lift to lift up to eighty pounds with about ten horsepower with only trim adjustments. Trim adjustments may be accomplished by diverting some of the rotor wash or entry air, or extendable lift surfaces on the trailing edge of the fixed, essentially vertical Array of air foil shaped vanes 1 or stubby vanes attached to the inside or outside diameter of the short, cylindrical vertical Duct 10, flared at the air entry end, entry air vanes, or the shape of the load for example. A vane 1 may be made of any material, preferably a light weight material that is rigid enough to withstand the rotor wash and swirl air flow component at varying load weights and rotor speeds.

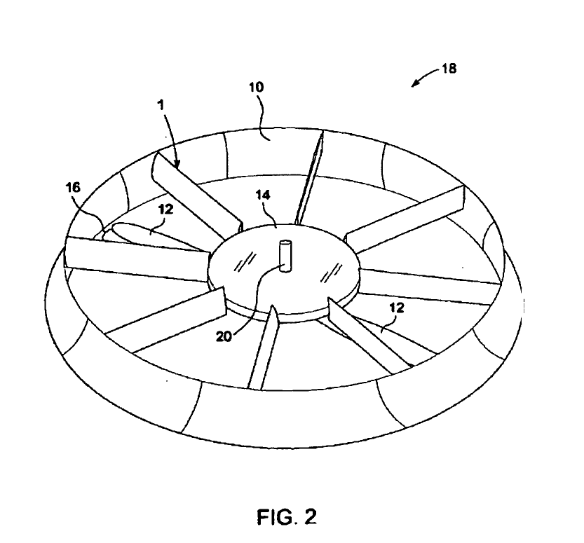

FIG. 2 is a bottom perspective view of a Torque-Balanced Lift rotor Module Assembly 18 consisting of a swirl air flow 16 a duct 10 surrounding an array of air foil shaped vanes 1 beneath a lift rotor 12 driven by a Lift rotor drive mechanism 20 and attached to the inside diameter of the Duct 10 below the lift rotor 12 and to a central control mount 14 at the other lengthwise end of each air foil shaped vane 1.

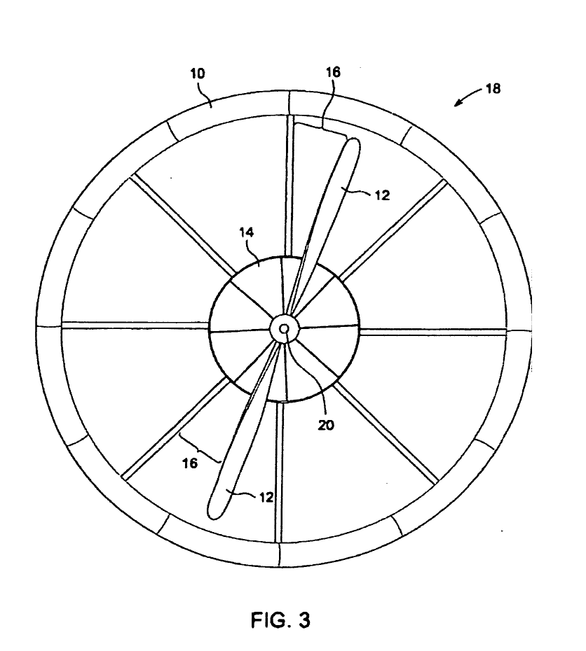

FIG. 3 is a top view of a Torque-Balanced Lift rotor Module Assembly 18 consisting of a swirl air flow 16 a duct 10 surrounding an array of air foil shaped vanes 1 beneath a lift rotor 12 driven by a Lift rotor drive mechanism 20 and attached to the inside diameter of the Duct 10 below the lift rotor 12 and to a central control mount 14 at the other lengthwise end of each air foil shaped vanes 1.

In operation the Lift rotor 12 attaches mechanically to a rotary torque generator through its Lift rotor drive mechanism 20 and uses the rotary torque to produce increased lift over a single Lift rotor 12 without the rest of the Torque-Balanced Lift rotor Module Assembly 18. Increased lift occurs because of the technically optimal fit, less than plus 0.5% of the Lift rotor 12 diameter of rotation, centered in the relatively short, cylindrical, vertical duct 10 inside diameter. The Lift rotor 12 horizontal plane of rotation is placed parallel to and just below the top of the flared entry end of the relatively short, cylindrical, vertical Duct 10. This open air in, ducted air out, type of the Duct 10, a type “B”, is effective for air drawn into the Duct 10 by a single Lift rotor 12 for fast, strong, smooth, exit air flow, producing maximal lift. The Array of vanes 1, when properly sized and oriented, act as an automatic anti-torque balance of torque requirements of a single Lift rotor 12 mechanism under varying load weights and power settings. In effect, they react to changes in torque with an equal but opposite change in anti-torque lateral lift.

Continuous torque balance is accomplished the Duct 10 serving to lock the function of the Lift rotor 12 together with the function of the Array of vanes 1. This locking together effect, causes torque balance to be continuous even during varying load weights and torque power settings. The properties of the Lift rotor 12 generated ducted air flow are forced to interact with the properties of the Array of vanes 1 in a synchronized manner. When one changes, the other changes in an equal but opposite way.

When a relatively light load is lifted by the Torque-Balanced Lift rotor Module Assembly 18, a relatively small amount of torque is required to turn the Lift rotor 12 at a certain pitch setting, to lift the load, which generates a relatively weak rotor wash with Swirl air flow 16 component contained by the Duct 10 and forced to interact with the Array of vanes 1 which generate a relatively small amount of anti-torque lateral lift and as a result, torque balance is achieved. When a heavier load is lifted by the same Torque-Balanced Lift rotor Module Assembly 18 relatively more torque is required to turn the rotor blade set at the same pitch, sufficient rounds per minute to lift the heavier load which creates a relatively stronger rotor wash with a relatively stronger Swirl air flow 16 component, which is forced by the Duct 10 to interact with the Array of vanes 1 and generate relatively stronger anti-torque lateral lift which maintains torque balance, excluding trim adjustments. Trim adjustments may be accomplished by various means. The constant, linearly generated interaction between the Lift rotor 12 and rotor wash with its Swirl air flow 16 component, contained by the Duct 10 inside diameter interacting with the shape and length of the Array of vanes 1, creates a condition wherein every increase or decrease in torque applied to the Lift rotor 12 creates an approximately equal but opposite anti-torque lateral lift response to produce constant torque balance and rotational control of a load being lifted and flown or moved horizontally under changing load, weight and torque force inputs.

A Torque-Balanced Lift rotor Module Assembly 18 with no moving parts is comprised of a fixed-pitch array of vanes 1 attached at one end to a centrally located control mount 14 and at the other end to the air exit end of a Duct 10. The array of vanes has a fixed-pitch less than 45 degrees from vertical. This Assembly 18 is capable of constant torque balance and rotational control of a load being lifted and flown or moved horizontally under changing load, weight and torque force inputs when installed on a VTOL craft, drone, or aerial crane.

A Torque-Balanced Lift rotor Module Assembly 18 with few moving parts is comprised of a fixed-pitch array of vanes 1 attached at one end to a centrally located control mount 14 and at the other end to the base, air exit end of a Duct 10, a lift rotor drive mechanism 20 passing through the control mount 14, and lift rotor 12 blades attached to and perpendicular to the lift rotor drive mechanism 20. The array of vanes has a fixed-pitch less than 45 degrees from vertical. This Assembly 18 is capable of constant torque balance and rotational control of a load being lifted and flown or moved horizontally under changing load, weight and torque force inputs when installed on a VTOL craft, drone or aerial crane.

Some Possible Configurations of a craft that incorporates a torque-balanced lift rotor module would configure a Lift rotor on top of a load; Lift rotor below a load; and Lift rotor below load with steering rotor above load.

### EXAMPLE 1

### Lift Rotor on Top of a Load

The BC style, lifts from the top. The pilot below the module steers by shifting their weight. The pilot might be configured in a harness or an enclosure. Yaw (counter rotation) is built into the module. Pitch and roll can be accomplished by weight-shift in the Body Copter configuration. A Torque-Balanced Lift rotor Module Assembly 18 is comprised of a fixed-pitch array of vanes 1 attached at one end to a centrally located control mount 14 and at the other end at the air exit end of a Duct 10, a lift rotor drive mechanism 20 passing through the control mount 14, and lift rotor 12 blades attached to and perpendicular to the lift rotor drive mechanism 20. A set of legs or landing platform is attached to the assembly. The pilot sits in a harness below the Assembly 18 and between the legs or within the landing platform.

### EXAMPLE 2

### Lift Rotor on Bottom, Load in Middle and of Load and a Top Mounted Articulated Steering Rotor

The Hover craft style craft lifts from bottom and steers with an articulated top rotor. Electronics may be placed inside an enclosure. An enclosure might be plexiglass or other material that protects the electronics, and if built on a large enough scale, the load might include a pilot and passengers and possibly cargo. Yaw (counter rotation) is built into the module. Pitch and roll can be accomplished with the articulated, steering (top) rotor on the Hover Copter. A Torque-Balanced Lift rotor Module Assembly 18 is comprised of a fixed-pitch array of vanes 1 attached at one end to a centrally located control mount 14 and at the other end to the base, air exit end of a Duct 10, a lift rotor drive mechanism 20 passing through the control mount 14, and lift rotor 12 blades attached to and perpendicular to the lift rotor drive mechanism 20. The array of vanes has a fixed-pitch less than 45 degrees from vertical. A platform or housing sits on a framework above the Assembly 18 to secure electronics, passengers and cargo. An articulated top rotor is attached to a framework above the load for steering.

### EXAMPLE 3

### Surveillance Device

As in example 2, The HC style craft lifts from bottom and steers with an articulated top rotor. Electronics may be placed inside an enclosure or on a platform for remote control fight or for predetermined flight path using GPS. An enclosure might be plexiglass or other material that protects the electronics, a camera or set of cameras is attached to the platform with the electronics for surveillance, mapping or search and rescue to see from above ground what people on the ground cannot see. Yaw (counter rotation) is built into the module. Pitch and roll can be accomplished with the articulated, steering (top) rotor on the Hover Copter. A Torque-Balanced Lift rotor Module Assembly 18 is comprised of a fixed-pitch array of vanes 1 attached at one end to a centrally located control mount 14 and at the other end at the air exit end of a Duct 10, a lift rotor drive mechanism 20 passing through the control mount 14, and lift rotor 12 blades attached to and perpendicular to the lift rotor drive mechanism 20. The array of vanes has a fixed-pitch. An articulated top rotor is attached to a framework above the load for steering.

### EXAMPLE 4

### Aerial Crane

An aerial crane may be configured to lift from top and to steer with an articulated top rotor. Electronics may be placed inside an enclosure or on a platform for remote control fight or for predetermined flight path using GPS. An enclosure might be plexiglass or other material that protects the electronics, a camera is attached to the platform with the electronics the remote operator to see the position of the craft. Yaw (counter rotation) is built into the module. Pitch and roll can be accomplished with an articulated rotor mounted on a framework above the electronics platform. A Torque-Balanced Lift rotor Module Assembly 18 is comprised of a fixed-pitch array of vanes 1 attached at one end to a centrally located control mount 14 and at the other end to the air exit end of a Duct 10, a lift rotor drive mechanism 20 passing through the control mount 14, and lift rotor 12 blades attached to and perpendicular to the lift rotor drive mechanism 20. The Assembly is attached to the framework below the electronics platform. A set of cables or straps are attached so that a load may be lifted from below the Assembly 18.

### EXAMPLE 5

### Remote Control Toy Craft

A toy craft could be of either the BC or the HC configuration only smaller in size and could be powered by BLDC motor, or gasoline. It could be radio controlled and flown inside or outside.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A device for continuous torque/anti-torque force balance of an aerial vehicle or lifting device comprising:
a) a relatively short, cylindrical, vertical duct having a flared at the top air entry end and a bottom air exit end;
b) a fixed-pitch, essentially vertical array of air foil shaped vanes, each vane having an outside end, an inside end, a leading edge and a trailing edge, the outside end is attached to the relatively short, cylindrical, vertical duct's inside diameter trailing edge ending at or near the bottom air exit end of the duct; and
c) The inside end attached to a Control mount; wherein the leading edge of the air foil shaped vanes points upward toward the duct's flared at the top air entry end.

2. The device of claim 1 further comprising a Lift rotor drive mechanism passing through the control mount

3. The device of claim 1 further comprising a lift rotor blades attached to the lift rotor drive mechanism.

4. The device of claim 1 further comprising lift rotor blades rigidly attached to the lift rotor drive mechanism.

5. The device of claim 3 wherein the single lift rotor is aligned perpendicular to the drive mechanism.

6. The device of claim 1 wherein the fixed-pitch, essentially vertical air foil shaped vanes are distributed evenly around the inside diameter of the duct.

7. The device of claim 1 wherein the fixed-pitch array of air foil shaped vanes is symmetrical or asymmetrical.

8. The device of claim 1 wherein the vanes are set at an angle between zero and 10 degrees from vertical.

9. The device of claim 1 wherein the vanes are set at an angle between zero and 20 degrees from vertical.

10. The device of claim 1 wherein the array of vanes trailing edges are attached to the duct at or near the air exit end of the duct.

11. A Vertical takeoff and landing, aerial vehicle or lifting device capable of continuous torque/anti-torque force balance, comprising:
a. a relatively short, cylindrical, vertical duct having a flared at the top air entry end and a bottom air exit end;
b. a fixed-pitch, essentially vertical array of air foil shaped vanes, each vane having an outside end, an inside end, a leading edge and a trailing edge, the outside ends attached to and distributed around the relatively short, cylindrical, vertical duct's inside diameter with trailing edges ending at or near the bottom air exit end of the duct;
c. the inside end attached to a Control mount; wherein the leading edge of the air foil shaped vanes points upward toward the duct's flared at the top air entry end;
d. a Lift rotor drive mechanism passing through the Control mount or being a rim drive added to the lift rotor diameter, by friction, chain, belt or magnetic; and
e. lift rotor blades attached to the lift rotor drive mechanism, wherein the vehicle is capable of continuous torque/anti-torque force balance.

12. A method of countering the torque generated by a single lift rotor, comprising: rotating the lift rotor within a vertical duct in a plane of rotation parallel to and just above a vertical or near vertical array of air foil shaped vanes; wherein lateral lift in an anti-torque direction results from rotor wash passing through the array of vanes.

13. The method of claim 12 wherein the anti-torque force countering the torque is sufficient to balance the torque.

14. The method of claim 12 wherein the inside diameter of the duct is closely fitted to the diameter of the lift rotor.

15. The method of claim 12 wherein the vertical duct is cylindrical.

16. The method of claim 12 wherein the vertical duct is flared at the top air entry end.

17. The method of claim 12 wherein the ratio of torque to anti-torque is maintained under varying load weights.

18. The method of claim 12 wherein the ratio of torque to anti-torque is maintained under varying power settings.
